(19) United States
(12) Patent Application Publication
(10) Pub. No.: US 2009/0106654 A1
(43) Pub. Date: Apr. 23, 2009

(54) BUSINESS TO MEDIA TRANSACTION BUSINESS PROCESS

(75) Inventors: Jacek Waksmundzki, Warsaw (PL); Pawel Demczuk, Warsaw (PL); Lukasz Michalski, Warsaw (PL)

Correspondence Address: MARSH, FISCHMANN & BREYFOGLE LLP, 8055 East Tufts Avenue, Suite 450, Denver, CO, 80237, US

(73) Assignee: Jacek Waksmundzki, Warsaw (PL)

(21) Appl. No.: 12/255,417

(22) Filed: Oct. 21, 2008

Related U.S. Application Data
(60) Provisional application No. 60/981,732, filed on Oct. 22, 2007.

(30) Foreign Application Priority Data
Aug. 29, 2008 (TW) 97133263

(51) Int. Cl. G06F 3/00; G06Q 30/00

(52) U.S. Cl. 715/700; 705/26

(57) ABSTRACT

A process of developing a computer network based universal transaction system. In one embodiment, such a process includes the steps of obtaining an offering interface broker, providing an offering system that an offering developer wants included in the computer network based universal transaction system with functionality of the offering system being extended by functionality provided by the offering interface broker, obtaining a marketplace interface broker, and providing a marketplace system that a marketplace supplier wants included in the computer network based universal transaction system with functionality of the marketplace system being extended by functionality provided by the marketplace interface broker.

### RELATED APPLICATION INFORMATION

This application claims priority from U.S. Provisional Patent Application Ser. No. 60/981,732 entitled “BUSINESS TO MEDIA TRANSACTION BUSINESS PROCESS” filed on Oct. 22, 2007, which is incorporated by reference herein in its entirety.

### FIELD OF THE INVENTION

The present invention relates generally to facilitating transactions among customers and offer providers, and more particularly to developing computer network connected systems for brokering of transactions relating to any goods or services in any business domain using multiple analog and digital media.

### BACKGROUND OF THE INVENTION

The Internet and other computer networks have proven to be a useful medium for connecting those who offer goods or services with persons seeking to obtain goods or services. For example, a patient might utilize the Internet to access their doctor's office Web site to schedule an appointment, a driver might access a car rental agency's Web site via the Internet to reserve a rental car, or a diner might utilize the Internet to access a restaurant's Web site to obtain a dinner reservation. In other examples, a person might order a pair of skis from a ski shop or an automobile part from an automobile parts dealer. In each of the foregoing examples, the ordering/scheduling function is integrated with the system that presents information about the available good/service. Furthermore, access to the system that presents information about the available goods/services may be limited to particular marketplaces. For example, the doctor's office, car rental agency's, restaurant's, ski shop's or parts dealer's Web site might be accessible via a Web portal, but not via a mobile phone portal or a digital television system. Additionally, the customers seeking goods/services may be presented with a myriad of different ordering/scheduling systems and processes in order to order/reserve a variety of differing goods/services since the customers directly interface with the offering systems.

### SUMMARY OF THE INVENTION

Accordingly, the present invention provides a process for developing a computer network based universal transaction system (CNBUTS) capable of performing every type transaction relating to wares between customers and offer providers in real time, simultaneously over every analog and digital media, in multiple digital marketplaces through a single universal agent. In general, a “ware” is any good or service that an individual or an entity may reserve, schedule, order, buy, purchase, sell, deliver, provide, receive, rent, lease, or the like from/to another. The terms “ware” and “good/service” may be used interchangeably herein. In general, a “customer” is any individual or entity that may reserve, schedule, order, buy, purchase, receive, rent, lease, or the like a good or service. The terms “customer” and “buyer/client” may be used interchangeably herein. Further, a “transaction” refers to any activity involving a good or service including reserving, scheduling, ordering, buying, purchasing, selling, delivering, providing, receiving, renting, leasing, or the like of a good or service.

One aspect of the process of the present invention is to establish the roles, responsibilities and interactions between various actors and components derived from the B2M transaction standard and the universal B2M transaction system. In general, the B2M transaction standard specifies a standard that provides for the visualization of, and the buying, renting/scheduling of goods/services, simultaneously, in real time, and over multiple analog and digital media in multiple analog and digital marketplaces. The B2M transaction standard is more specifically described in a separate United States patent application filed contemporaneously herewith entitled “BUSINESS TO MEDIA TRANSACTION STANDARD” (which application claims priority from U.S. Provisional Application Ser. No. 60/981,722 filed Oct. 22, 2007), the entire disclosure of which is incorporated by reference herein. In general the universal B2M transaction system provides a system that provides easy brokering of transactions relating to wares between customers and offer providers. The universal B2M transaction system is more specifically described in a separate United States patent application filed contemporaneously herewith entitled “UNIVERSAL BUSINESS TO MEDIA TRANSACTION SYSTEM” (which application claims priority from U.S. Provisional Application Ser. No. 60/981,710 filed Oct. 22, 2007), the entire disclosure of which is incorporated by reference herein. In accordance with this aspect, this covers the following:

a. Universal B2M transaction system's development process;

b. Universal B2M transaction system's modules ownership; and

c. Universal B2M transaction system's open structure which enables the following:
i. the ability to offer transaction services to different kinds of domains (e.g. auto parts, medical reservations and ski rental),
ii. the ability to use different technologies and programming languages (e.g. Windows, Unix and OS X/PHP and Java),
iii. the ability to use different languages (e.g. English, German, French and Polish),
iv. the ability to implement a variety of business logic approaches (e.g. goods/service bundles and linked goods/services),
v. the ability to offer access to the system via every analog and digital media (e.g. newspaper, billboard, Internet and cell phone), over multiple marketplaces (e.g. domain specific, geographic, bundled and universal).

In one embodiment, the process of the present invention may be presented as a process combining cooperation and interaction of three groups of actors and six components. The three actors are: one or more marketplace suppliers, a universal transaction system operator (UTSO), and one or more offering developers. The components owned by the universal transaction system operator may include: a marketplace interface broker (MIB), an offering interface broker (OIB), and a universal agent. Components that are part of the process but are external to the universal transaction system operator may belong to the marketplace suppliers and offering developers. Such components include, respectively, marketplaces belonging to marketplace suppliers and offering systems belonging to offering developers. Both groups may also own media interfaces.

The universal transaction system operator may develop the universal agent, the marketplace interface broker and the offering interface broker. Marketplace suppliers receive the marketplace interface broker and develop marketplaces (the buyer's/client's interfaces to CNBUTS). Offering developers receive the offering interface broker and develop offering systems (offer provider interfaces to CNBUTS).

The process of developing CNBUTS allows:
developing a transaction system with marketplaces and offering systems separated from the universal agent.
creating a transaction system with particular components belonging to different owners, and
creating a transaction system with multiple marketplaces and offering systems.

By using MIB and OIB in accordance with the presented process, the transaction system becomes truly universal and can offer transaction services to different kinds of transaction domains (e.g. computer selling, medical services and ski rental, etc.). This is possible due to the fact that CNBUTS is not developed by only one or several developers but it can have as many domain-specific marketplace suppliers and offering developers as the universal agent is able to serve.

With the MIB and OIB being operating system and programming language agnostic and following the presented process of using them, CNBUTS can be made available for all leading technologies and programming languages.

In one embodiment, the process of the present invention states that buyer's/client's and offer provider's interfaces within the CNBUTS are developed independently from the UTSO by different entities. This implicates that language used within graphical user interfaces (GUIs) developed by marketplace suppliers and offering developers depends only on the perceived market needs which allow the system conditions to become multi language with a potentially unlimited number of supported languages.

The process of the present invention also allows for the possibility of developing CNBUTS with an unlimited number of offering systems developed by different entities (offering developers).

The process of the present invention further allows for the possibility of developing CNBUTS with an unlimited number of marketplaces developed by different entities (marketplace suppliers).

The process of the present invention also gives marketplace suppliers freedom in the marketplace development process. Marketplace suppliers can choose what kind and what number of business domains available at the universal agent they want to offer on their marketplaces and how interaction with the buyer/client should look like. As this invention lets an unlimited number of marketplace suppliers cooperate with CNBUTS, the number of marketplaces with different business logics is also potentially unlimited.

The present invention includes various additional aspects and features. In one more aspect, a process of developing a computer network based universal transaction system includes the steps of obtaining an offering interface broker, providing an offering system, obtaining a marketplace interface broker, and providing a marketplace system. The offering system may be one that an offering developer wants included in the computer network based universal transaction system, with functionality of the offering system being extended by functionality provided by the offering interface broker. The marketplace system may be one that a marketplace supplier wants included in the computer network based universal transaction system, with functionality of the marketplace system being extended by functionality provided by the marketplace interface broker.

In yet one more aspect, a process of developing a computer network based universal transaction system that enables transactions among one or more customers and one or more offer providers relating to wares offered by the offer providers includes the steps of providing a universal agent system, providing an offering interface broker to an offering developer, and providing a marketplace interface broker to a marketplace supplier. In providing an offering interface broker to an offering developer, the offering interface broker may be usable by the offering developer to develop an offering system including functionality provided by the offering interface broker when there is not an existing offering system that the offering developer wants included in the computer network based universal transaction system and to add functionality provided by the offering interface broker to an existing offering system when there is an existing offering system that an offering developer wants included in the computer network based universal transaction system, with functionality of the offering system being extended by functionality provided by the offering interface broker. In providing a marketplace interface broker to a marketplace supplier, the marketplace interface broker may be usable by the marketplace supplier to develop a marketplace system including functionality provided by the marketplace interface broker when there is not an existing marketplace system that the marketplace supplier wants included in the computer network based universal transaction system and to add functionality provided by the marketplace interface broker to an existing marketplace system when there is an existing marketplace system that a marketplace supplier wants included in the computer network based universal transaction system, with functionality of the marketplace system being extended by functionality provided by the marketplace interface broker. The process may also include the step of including in the computer network based universal transaction system at least one of the universal agent system, the offering system with the functionality provided by the offering interface broker, and the marketplace system with the functionality provided by the marketplace interface broker.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 is a block diagram showing one embodiment of a computer network based universal transaction system presenting involved actors and components; and

FIG. 2 shows one embodiment of a computer network based universal transaction system development process.

### DETAILED DESCRIPTION

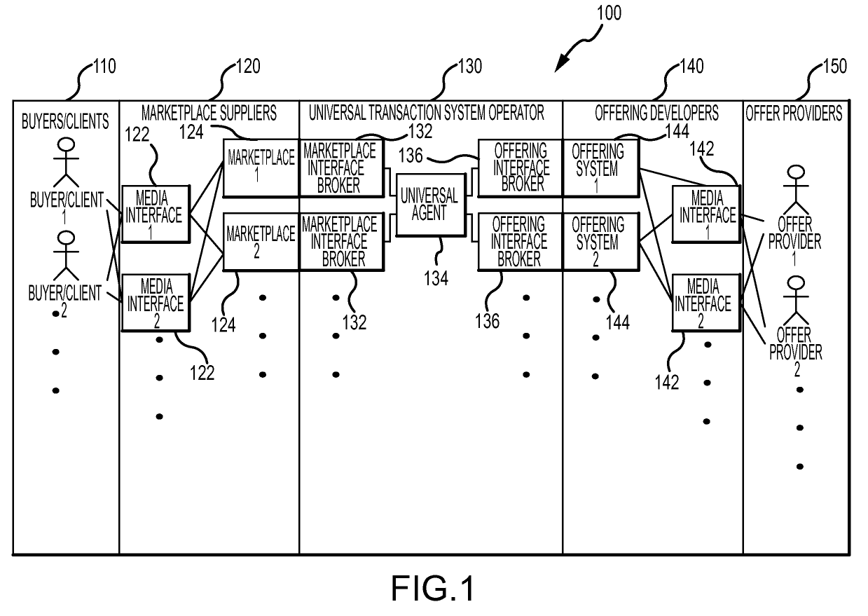

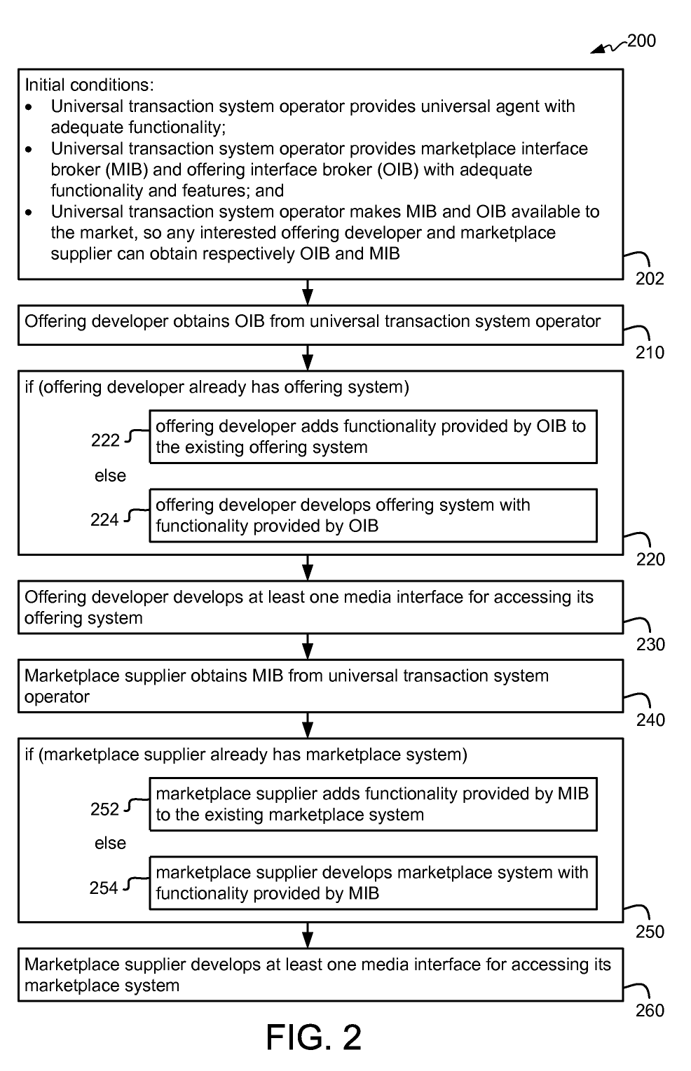

FIG. 1 depicts one embodiment of a CNBUTS 100 that may be developed using the CNBUTS development process 200, one embodiment of which is presented in FIG. 2. The CNBUTS development process 200 combines interactions of three (3) groups of actors and six (6) component types (see FIG. 1). Component types used in this process include:
A media interface 122, 142 is a set of all tools (e.g. php-html scripts, OpenTV applications, etc.) needed to support buyer/client 110 to marketplace 124, marketplace 124 to buyer/client 110, offer provider 150 to offering system 144, and offering system 144 to offer provider 150 directed communication through digital media (e.g. mobile phone with an Internet browser, PC with an Internet browser, etc.). The media interface 122 is also a set of tools (e.g. graphics, texts, etc.) needed to enable marketplace 124 to buyer/client 110 directed communication through analog media (e.g. billboards, newspapers, etc.).
A marketplace 124 is a computer network enabled computer system where goods/services are available through media interfaces 122 to the buyers/clients 110. In this regard, marketplaces 124 may also be referred to herein as marketplace systems 124.
A marketplace interface broker (MIB) 132 is a tool integrating marketplaces 124 with a universal agent 134. The MIB 132 provides functionality enabling different kinds of marketplaces 124 to be connected to the universal agent 134.
A universal agent 134 is a computer network enabled computer system capable of processing transactions of goods/services on behalf of an offer provider 150 and handling transactions between marketplace interface brokers 132 and offering interface brokers 136. In this regard, the universal agent 134 may also be referred to herein as the universal agent system 134. The universal agent 134 is connected via a computer network (not shown) to one or more offering systems 144 using offering interface brokers 136 and to marketplaces 124 using marketplace interface brokers 132.
An offering interface broker (OIB) 136 is a tool integrating offering systems 144 with the universal agent 134. The OIB 136 provides functionality enabling different kinds of offering systems 144 to be connected to the universal agent 134.
An offering system 144 is a computer network enabled computer system where goods/services are defined and managed by offer providers 150 through media interfaces 142.
   The actors cooperating in the process of developing CNBUTS include:
A universal transaction system operator 130 that is the provider of three components: the universal agent 134, the marketplace interface broker 132 and the offering interface broker 136.
A marketplace supplier 120 that is the developer of one or more marketplaces 124 and one or more media interfaces 122.
An offering developer 140 that is the developer of one or more offering systems 144 and one or more media interfaces 142.

CNBUTS development may proceed in accordance with a process 200 such as depicted in FIG. 2. When the CNBUTS development process begins, there are several initial conditions 202 including: (1) the universal transaction system operator 130 provides the universal agent 134 with adequate functionality; (2) the universal transaction system operator 130 provides the MIB 132 and the OIB 136 with the adequate functionality and features; and (3) the universal transaction system operator 130 makes the MIB 132 and the OIB 136 available to the market, so any interested offering developer 140 and marketplace supplier 120 can obtain, respectively, the OIB 136 and the MIB 132.

With the initial conditions 202 satisfied, one embodiment of the CNBUTS development process 200 proceeds in the following manner. In a first step 210, the offering developer 140 obtains the OIB 136 from the universal transaction system operator 130. In a second step 220 the offering developer undertakes one of two sub-steps. If the offering developer 140 already has an offering system 144, the offering developer 140 undertakes sub-step 222 wherein the offering developer 140 adds functionality provided by the OIB 136 to the existing offering system 144; else, the offering developer 140 undertakes sub-step 224 wherein the offering developer 140 develops an offering system 144 with functionality provided by the OIB 136. In a third step 230, the offering developer 140 develops at least one media interface 142 for accessing its offering system 144.

In a fourth step 240, the marketplace supplier 120 obtains the MIB 132 from the universal transaction system operator 130. In a fifth step 250, the marketplace supplier 120 undertakes one of two sub-steps. If the marketplace supplier 120 already has a marketplace system 124, the marketplace supplier 120 undertakes sub-step 252 wherein the marketplace supplier 120 adds functionality provided by the MIB 132 to the existing marketplace system 124; else, the marketplace supplier 120 undertakes sub-step 254 wherein the marketplace supplier 120 develops the marketplace system 124 with functionality provided by the MIB 132. In a sixth step 260, the marketplace supplier 120 develops at least one media interface 122 for accessing its marketplace system 120.

In other embodiments of the CNBUTS development process, the order of one or more of the aforementioned steps (210-260) may be arranged in a different manner. For example, steps undertaken by the offering developer 140 (e.g., steps 210-230) may proceed in parallel with the steps undertaken by the marketplace supplier 120 (e.g., steps 240-260) or after the steps undertaken by the marketplace supplier 120. Regardless of the order in which the steps are arranged, the CNBUTS 100 starts to work at its full functionality when at least one offering developer 140 and at least one marketplace supplier 120 fulfill their respective activities of the CNBUTS development process 200.

### Ownership of CNBUTS

Actors (e.g., the universal transaction system operator 130, marketplace suppliers 120 and offering developers 140) participating in development of CNBUTS 100 partially own the system 100 by owning its specified elements. Three groups of actors and their components are listed below:
The universal transaction system operator 130 owns the universal agent system 134, the offering interface broker 136 and the marketplace interface broker 132,
Each offering developer 140 owns at least one offering system 144 and at least one media interface 142, and
Each marketplace supplier 120 owns at least one marketplace system 124 and at least one media interface 122.
   While there is only one universal transaction system operator 130, the number of offering developers 140 and marketplace suppliers 120 participating in developing a CNBUTS 100 is not limited.

### Roles and Responsibilities

The role of the universal transaction system operator 130 in the CNBUTS development process 200 includes:
supplying marketplace suppliers 120 and offering developers 140, respectively, with MIBs 132 and OTBs 136;
assuring error-free and secure communication between provided MIBs 132 and OTBs 136;
providing the universal agent 134 which will operate efficiently and reliably; and
providing the functionality that satisfies marketplace suppliers 120 and offering developers 140 needs according to the CNBUTS 100.

The role of marketplace suppliers 120 includes:
building marketplaces 124 in any area of perceived market need (e.g. auto parts, hair-dressers, ski rentals, hotels, etc.);
establishing the tailored user interfaces for marketplaces 124;
linking or excluding goods/service domains in order to improve the buyer/client experience on a given marketplace 124; and
providing access to marketplaces 124 to the buyers/clients 110 through required analog and digital media by media interfaces 122 (e.g. newspapers, billboards, cell phones, WWW sites, digital TV applications, etc.).

The role of offering developers 140 includes:
building offering systems 144 in any perceived need business domain (e.g. computer sales, auto parts, hair-dressers, ski rentals, hotels, etc.);
establishing the tailored user interfaces for offering systems 144;
developing offer provider's 150 transaction delegations within offering systems 144;
developing functionality of assigning offer provider's 150 offer to a unique universal service code;
linking to offering systems 144 any other domain-specific tools (e.g. patient medical records, restaurant table configuration, etc.); and
providing access to offering systems 144 to the offer providers 150 through required digital media by media interfaces 142 (e.g. cell phone applications, WWW applications, digital TV applications, computer network enabled local applications, etc.).

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A process of developing a computer network based universal transaction system, said process comprising the steps of:
obtaining an offering interface broker;
providing an offering system that an offering developer wants included in the computer network based universal transaction system, wherein functionality of the offering system is extended by functionality provided by the offering interface broker;
obtaining a marketplace interface broker; and
providing a marketplace system that a marketplace supplier wants included in the computer network based universal transaction system, wherein functionality of the marketplace system is extended by functionality provided by the marketplace interface broker.

2. The process of claim 1 wherein the offering interface broker is obtained from a universal transaction system operator by the offering developer.

3. The process of claim 1 wherein the marketplace interface broker is obtained from a universal transaction system operator by the marketplace supplier.

4. The process of claim 1 further comprising the step of:
developing at least one media interface for accessing the offering system.

5. The process of claim 4 wherein the at least one media interface is developed by the offering developer.

6. The process of claim 4 wherein the at least one media interface enables two-way communication between the offering system and an offer provider, wherein the at least one media interface enables operation of the offering system by the offer provider to define offers of wares available for transaction.

7. The process of claim 1 further comprising the step of:
developing at least one media interface for accessing the marketplace system.

8. The process of claim 7 wherein the at least one media interface is developed by the marketplace supplier.

9. The process of claim 7 wherein the at least one media interface provides at least one-way communication from the marketplace system to customers, wherein offers of wares available for transaction defined by an offer provider are communicated from the marketplace system to the customers via the at least one media interface.

10. The process of claim 9 wherein the at least one media interface provides two-way communication between the marketplace system and the customers, wherein transaction requests by the customers are communicated from the customers to the marketplace system via the same at least one media interface.

11. The process of claim 9 wherein at least one additional media interface provides at least return channel communication from the customers to the marketplace systems, and wherein transaction requests by the customers are communicated from the customers to the marketplace system via the at least one additional media interface.

12. The process of claim 1 further comprising:
providing a universal agent system.

13. The process of claim 12 further comprising:
including in the computer network based universal transaction system at least one of the universal agent system, the offering system with the functionality provided by the offering interface broker, and the marketplace system with the functionality provided by the marketplace interface broker.

14. The process of claim 12 wherein the universal agent system is provided by a universal transaction system operator.

15. The process of claim 1 wherein said step of providing an offering system comprises:
developing an offering system including functionality provided by the offering interface broker when there is not an existing offering system that the offering developer wants included in the computer network based universal transaction system.

16. The process of claim 15 wherein said step of developing an offering system including functionality provided by the offering interface broker is performed by the offering developer.

17. The process of claim 1 wherein said step of providing a marketplace system comprises:
developing a marketplace system including functionality provided by the marketplace interface broker when there is not an existing marketplace system that the marketplace supplier wants included in the computer network based universal transaction system.

18. The process of claim 17 wherein said step of developing a marketplace system including functionality provided by the marketplace interface broker is performed by the marketplace supplier.

19. The process of claim 1 wherein said step of providing an offering system comprises:
adding functionality provided by the offering interface broker to an existing offering system when there is an existing offering system that an offering developer wants included in the computer network based universal transaction system.

20. The process of claim 19 wherein said step of adding functionality provided by the offering interface broker to an existing offering system is performed by the offering developer.

21. The process of claim 1 wherein said step of providing a marketplace system comprises:
adding functionality provided by the marketplace interface broker to an existing marketplace system when there is an existing marketplace system that a marketplace supplier wants included in the computer network based universal transaction system.

22. The process of claim 21 wherein said step of adding functionality provided by the marketplace interface broker to an existing marketplace system is performed by the marketplace supplier.

23. A process of developing a computer network based universal transaction system that enables transactions among one or more customers and one or more offer providers relating to wares offered by the offer providers, said process comprising the steps of:
providing a universal agent system;
providing an offering interface broker to an offering developer, wherein the offering interface broker is usable by the offering developer to develop an offering system including functionality provided by the offering interface broker when there is not an existing offering system that the offering developer wants included in the computer network based universal transaction system and to add functionality provided by the offering interface broker to an existing offering system when there is an existing offering system that an offering developer wants included in the computer network based universal transaction system, and wherein functionality of the offering system is extended by functionality provided by the offering interface broker;
providing a marketplace interface broker to a marketplace supplier, wherein the marketplace interface broker is usable by the marketplace supplier to develop a marketplace system including functionality provided by the marketplace interface broker when there is not an existing marketplace system that the marketplace supplier wants included in the computer network based universal transaction system and to add functionality provided by the marketplace interface broker to an existing marketplace system when there is an existing marketplace system that a marketplace supplier wants included in the computer network based universal transaction system, and wherein functionality of the marketplace system is extended by functionality provided by the marketplace interface broker; and
including in the computer network based universal transaction system at least one of the universal agent system, the offering system with the functionality provided by the offering interface broker, and the marketplace system with the functionality provided by the marketplace interface broker.

24. The process of claim 23 further comprising the step of:
developing at least one media interface for accessing the offering system.

25. The process of claim 24 wherein the at least one media interface is developed by the offering developer.

26. The process of claim 24 wherein the at least one media interface enables two-way communication between the offering system and an offer provider, wherein the at least one media interface enables operation of the offering system by the offer provider to define offers of wares available for transaction.

27. The process of claim 23 further comprising the step of:
developing at least one media interface for accessing the marketplace system.

28. The process of claim 27 wherein the at least one media interface is developed by the marketplace supplier.

29. The process of claim 27 wherein the at least one media interface provides at least one-way communication from the marketplace system to customers, wherein offers of wares available for transaction defined by an offer provider are communicated from the marketplace system to the customers via the at least one media interface.

30. The process of claim 29 wherein the at least one media interface provides two-way communication between the marketplace system and the customers, wherein transaction requests by the customers are communicated from the customers to the marketplace system via the same at least one media interface.

31. The process of claim 29 wherein at least one additional media interface provides at least return channel communication from the customers to the marketplace systems, and wherein transaction requests by the customers are communicated from the customers to the marketplace system via the at least one additional media interface.

32. The process of claim 23 wherein the ware comprises a good.

33. The process of claim 23 wherein the ware comprises a service.
